(19) United States
(12) Patent Application Publication
(10) Pub. No.: US 2025/0042824 A1
(43) Pub. Date: Feb. 6, 2025

(54) STRAW HUMIFICATION PROCESSING METHOD

(71) Applicant: CHANGCHUN XINRUIDE NEW MATERIAL TECHNOLOGY DEVELOPMENT CO., LTD., CHANGCHUN (CN)

(72) Inventor: XIANDE SHEN, CHANGCHUN (CN)

(21) Appl. No.: 18/362,118

(22) Filed: Jul. 31, 2023

(51) Int. Cl. C05F 11/02

(52) U.S. Cl. CPC C05F 11/02

(57) ABSTRACT

A straw humification processing method includes steps of washing and smashing raw material to obtain smashed raw material, putting the smashed raw material into a reaction kettle, adding a sodium chloride solution into the reaction kettle, adding acetone into the reaction kettle, reacting under a protection of nitrogen, and taking out reactants and filtering to obtain a humic material. Through an effective processing of the raw material, the humus material with an organic matter content of 60%-70% is obtained, and the humus material is applied to soil improvement to effectively increase the organic matter content in soil. The straw humification processing method is simple and has a high utilization rate of the raw material.

### TECHNICAL FIELD

The present disclosure relates to a technical field of biological materials, and in particular to a straw humification processing method.

### BACKGROUND

Straw is one of main sources of biomass materials. China produces 800-900 million tons of straw every year. An effective use of straw is of great significance in protecting cultivated land and forest land, controlling agricultural non-point source pollution, preventing and controlling air pollution, changing the mode of agricultural development, and sustainable agricultural development. At this stage, China has many problems to be solved urgently in terms of straw processing and soil structure improvement.

In terms of straw processing, under a guidance of active policies of the Chinese government, extensive research has been carried out on an comprehensive utilization of “five materials”, such as using the straw as fertilizer, feed, raw material, base material, and fuel, which greatly improves comprehensive utilization efficiency of the straw. However, a “five-materialization” straw utilization technology still has problems such as immature technology, low production efficiency, high energy consumption, lack of industry standards, and unobvious economic benefits. Therefore, the straw produced cannot be effectively utilized, resulting in large-scale burning of the straw every summer and autumn and causing serious damage to the environment. Thus, how to effectively treat biomass materials such as the straw is an urgent problem to be solved in the prior art.

In terms of soil structure improvement, soil fertility of agricultural soil in China is decreased significantly due to long-term high-intensity use. For example, as an organic matter content of the agricultural soil in Northeast China has dropped from 10% to less than 2.5% in the past 50 years, there have also been phenomena such as increased alkalinity and compaction of the agricultural soil in Northeast China. At present, carbon-based organic fertilizer materials promoted on the market contain carbon treated at a high temperature of 500-600° C., which is an inorganic material, shows alkalinity, and is difficult to be absorbed by the soil. Moreover the carbon-based organic fertilizer materials also increase the alkalinity of the soil, which are not suitable for large-scale promotion. Although the Chinese government has promoted techniques of testing soil properties and formulating corresponding fertilizers to improve an organic matter content of the agricultural soil, the organic matter content of the agricultural soil in China is still generally lower than that of the agricultural soil in foreign countries. Therefore, the organic matter content of the agricultural soil in China urgently needs to be increased to effectively protect black soil and ensure food security in China.

To sum up, how to effectively treat the straw to improve the organic matter content in the agricultural soil is an urgent problem to be solved by those skilled in the art.

### SUMMARY

A main purpose of embodiments of the present disclosure is to provide a straw humification processing method, aiming at effectively treating straw, and products obtained can be used to improve an organic matter content of soil.

To achieve the above object, the present disclosure provides the straw humification processing method. The straw humification processing method comprises following steps:
washing and smashing raw material to obtain smashed raw material;
putting the smashed raw material into a reaction kettle, adding a sodium chloride solution into the reaction kettle, adding acetone into the reaction kettle, and reacting under a protection of nitrogen; and
taking out reactants and filtering to obtain a humic material.

In one embodiment, the step of washing and smashing the raw material to obtain the smashed raw material comprises:
washing the raw material in a water washing tank to remove impurities; and
smashing cleaned raw material into particles having a size of 5 mm-20 mm by a pulverizer.

In one embodiment, the step of putting the smashed raw material into the reaction kettle, adding the sodium chloride solution into the reaction kettle, adding the acetone into the reaction kettle, and reacting under the protection of the nitrogen comprises:
adding the smashed raw material and the sodium chloride solution with a concentration of 0.1%-0.3% into the reaction kettle according to a solid-to-liquid ratio of 1:6-1:12, and adding the acetone with a weight ratio of 0.5%; and
introducing the nitrogen into the reaction kettle, and stirring and reacting solid-liquid reactants in the reaction kettle under a heating state for 40-80 min.

In one embodiment, in the step of introducing the nitrogen into the reaction kettle, and stirring and reacting the solid-liquid reactants in the reaction kettle under the heating state for 40-80 min, a heating temperature is 180-220° C.

In one embodiment, the step of taking out the reactants and filtering to obtain the humic material comprises introducing reacted solid-liquid reactants into a solid-liquid separation device to obtain a solid humic material when a temperature of the reaction kettle is lowered to 50-70° C.

In one embodiment, the step of taking out the reactants and filtering to obtain the humic material further comprises concentrating a liquid solution obtained after filtering into a feed additive. When the liquid solution is concentrated into the feed additive, water separated in a concentration process is used in the step of washing and smashing the raw material.

In one embodiment, in the step of taking out the reactants and filtering to obtain the humic material, a carbon content of the humus material is 40%-50%, and an organic matter content of the humus material is 6%-70%.

In the present disclosure, through an effective processing of the raw material, the humus material with the organic matter content of 60%-70% is obtained, and the humus material is applied to soil improvement to effectively increase an organic matter content in soil. The straw humification processing method of the present disclosure is simple and has a high utilization rate of the raw material.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a flow chart of a straw humification processing method according to one embodiment of the present disclosure.

FIG. 2 is another flow chart of the straw humification processing method according to one embodiment of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

It should be noted that all directional indications (such as up, down, left, right, front, back . . . ) in the embodiments of the present disclosure are only used to explain the relationship, relative positional relationship, movement conditions, etc., between the components in a specific posture (as shown in the drawings), if the specific posture changes, the directional indications change accordingly.

It should be understood in the description of the present disclosure that terms such as “first” and “second” are only used for the purpose of description, rather than being understood to indicate or imply relative importance or hint the number of indicated technical features. Thus, the feature limited by “first” and “second” can explicitly or impliedly include at least one feature. In the description of the present disclosure, the meaning of “a plurality of” is at least two, e.g., two or three, or more unless otherwise specified.

It should be noted in the description of the present disclosure that, unless otherwise regulated and defined, terms such as “installation”, “bonded”, and “connection” shall be understood in broad sense, and for example, may refer to fixed connection or detachable connection or integral connection; may refer to mechanical connection or electrical connection; and may refer to direct connection or indirect connection through an intermediate medium or inner communication of two elements. For those of ordinary skill in the art, the meanings of the above terms in the present disclosure may be understood according to concrete conditions.

In addition, the technical solutions between various embodiments may be combined with each other, but the combination should be realized by those skilled in the art. When the combination of the technical solutions is contradictory or cannot be implemented, it should be considered that the combination of the technical solutions does not exist or is not within the protection scope of the present disclosure.

Specific steps of a straw humification processing method proposed by the present disclosure will be described below in specific embodiments.

### Embodiment 1

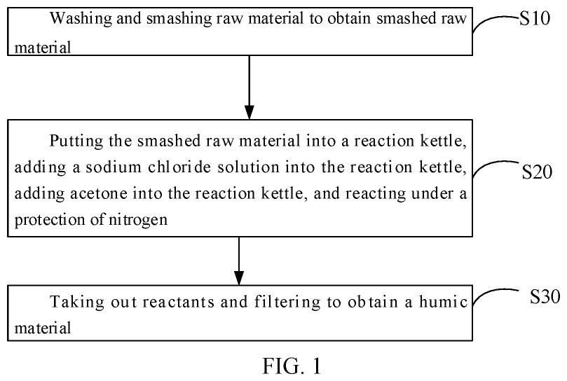

As shown in FIG. 1, the straw humification processing method comprises following steps:
S10: washing and smashing raw material to obtain smashed raw material;
S20: putting the smashed raw material into a reaction kettle, adding a sodium chloride solution into the reaction kettle, adding acetone into the reaction kettle, and reacting under a protection of nitrogen; and
S30: taking out reactants and filtering to obtain a humic material.

The reactants are solid-liquid reactants. It is understood that a carbon content of the humus material is 40%-50%, and an organic matter content of the humus material is 6%-70%.

### Embodiment 2

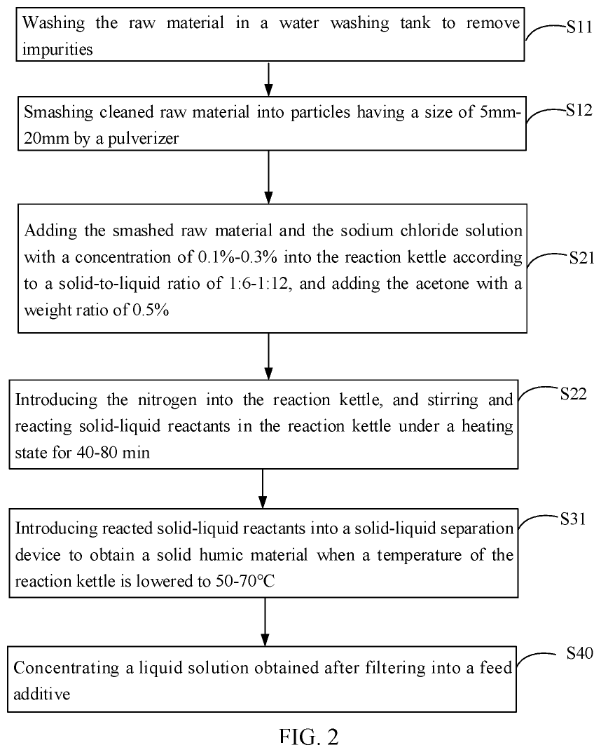

As shown in FIG. 2, the straw humification processing method comprises following steps:
S11: washing the raw material in a water washing tank to remove impurities; Optionally, the raw material is corn stalks, and the corn stalks are placed in the water washing tank for washing to remove the impurities such as metal and sand.
S12: smashing cleaned raw material into particles having a size of 5 mm-20 mm by a pulverizer.

Optionally, cleaned corn stalks are smashed to 10 mm particles by a YD200 pulverizer.
S21: adding the smashed raw material and the sodium chloride solution with a concentration of 0.1%-0.3% into the reaction kettle according to a solid-to-liquid ratio of 1:6-1:12, and adding the acetone with a weight ratio of 0.5%;

Optionally, smashed corn stalks and the sodium chloride solution (with a concentration of 0.1%) are added to the reaction kettle made of stainless steel at a ratio of 1:10 (m/v).
S22: introducing the nitrogen into the reaction kettle, and stirring and reacting solid-liquid reactants in the reaction kettle under a heating state for 40-80 min;

Optionally, the nitrogen is introduced into the reaction kettle for 3-5 minutes to replace air in the reaction kettle, then the reaction kettle is heat to 200° C., and the solid-liquid reactants in the reaction kettle are stirred, so the smashed corn stalks and sodium chloride solution are fully reacted, and a reaction time is 60 min.
S31: introducing reacted solid-liquid reactants into a solid-liquid separation device to obtain a solid humic material when a temperature of the reaction kettle is lowered to 50-70° C.; and

Optionally, after reacting for 60 min, the temperature of the reaction kettle is lowered to 60° C., and the reacted solid-liquid reactants are introduced into the solid-liquid separation device to obtain the solid humus material. The carbon content of the solid humus material is 45%, and the organic matter content of the solid humus material is 61%.
S32: concentrating a liquid solution obtained after filtering into a feed additive.

When the liquid solution is concentrated into the feed additive, water separated in a concentration process is used in the step S11. The feed additive comprises antibacterial, anti-inflammatory, and nutritional substances, such as arabinose, mannose, xylobiose, glucose, xylose, cellobiose, etc.

The above are only optional embodiments of the present disclosure, but the protection scope of the present disclosure is not limited thereto. Any changes or substitutions that can be easily conceived by those skilled in the art within the technical scope disclosed in the present disclosure shall be fall in the protection scope of the present disclosure. Therefore, the protection scope of the present disclosure should be determined by the protection scope of the claims.

What is claimed is:

1. A straw humification processing method, comprising following steps:
washing and smashing raw material to obtain smashed raw material;
putting the smashed raw material into a reaction kettle, adding a sodium chloride solution into the reaction kettle, adding acetone into the reaction kettle, and reacting under a protection of nitrogen; and
taking out reactants and filtering to obtain a humic material.

2. The straw humification processing method according to claim 1, wherein the step of washing and smashing the raw material to obtain the smashed raw material comprises:
washing the raw material in a water washing tank to remove impurities; and
smashing cleaned raw material into particles having a size of 5-20 mm by a pulverizer.

3. The straw humification processing method according to claim 1, wherein the step of putting the smashed raw material into the reaction kettle, adding the sodium chloride solution into the reaction kettle, adding the acetone into the reaction kettle, and reacting under the protection of the nitrogen comprises:
adding the smashed raw material and the sodium chloride solution with a concentration of 0.1%-0.3% into the reaction kettle according to a solid-to-liquid ratio of 1:6-1:12, and adding the acetone with a weight ratio of 0.5%; and
introducing the nitrogen into the reaction kettle, and stirring and reacting solid-liquid reactants in the reaction kettle under a heating state for 40-80 min.

4. The straw humification processing method according to claim 3, wherein in the step of introducing the nitrogen into the reaction kettle, and stirring and reacting the solid-liquid reactants in the reaction kettle under the heating state for 40-80 min, a heating temperature is 180-220° C.

5. The straw humification processing method according to claim 1, wherein the step of taking out the reactants and filtering to obtain the humic material comprises:
introducing reacted solid-liquid reactants into a solid-liquid separation device to obtain a solid humic material when a temperature of the reaction kettle is lowered to 50-70° C.

6. The straw humification processing method according to claim 1, wherein the step of taking out the reactants and filtering to obtain the humic material further comprises concentrating a liquid solution obtained after filtering into a feed additive;
when the liquid solution is concentrated into the feed additive, water separated in a concentration process is used in the step of washing and smashing the raw material.

7. The straw humification processing method according to claim 1, wherein in the step of taking out the reactants and filtering to obtain the humic material, a carbon content of the humus material is 40%-50%, and an organic matter content of the humus material is 6%-70%.
